(19) United States
(12) Patent Application Publication
(10) Pub. No.: US 2026/0087954 A1
(43) Pub. Date: Mar. 26, 2026

(54) Content-Dependent Thermal Profile

(71) Applicant: Apple Inc., Cupertino, CA (US)

(72) Inventors: Mahesh B. Chappalli, San Jose, CA (US); Justin L. Tracy, San Jose, CA (US); Judith C. Segura, San Francisco, CA (US); Jie Won Ryu, San Jose, CA (US); Meir Harar, Tel-Aviv (IL); Kanuo C. Kustra, San Jose, CA (US); Myungjoon Choi, San Diego, CA (US); Hyunwoo Nho, Palo Alto, CA (US); Kevin J. Ryan, Mountain View, CA (US)

(21) Appl. No.: 19/086,112

(22) Filed: Mar. 20, 2025

Related U.S. Application Data
(60) Provisional application No. 63/699,718, filed on Sep. 26, 2024.

(51) Int. Cl. G09G 3/00; G01K 1/02; G01K 3/08; G01K 7/02; G09G 5/02

(52) U.S. Cl. CPC G09G 3/006; G01K 1/026; G01K 3/08; G01K 7/02; G09G 5/02; G09G 2320/0242; G09G 2320/041; G09G 2330/12

(57) ABSTRACT

Systems and methods for compensating for temperature-based variation of a pixel of a display may include receiving image data to be adjusted for display via the electronic display, receiving temperature measurements at a plurality of locations of the electronic display, generating a heat model of the electronic display based on the image data, determining a temperature of the pixel based on the heat model of the electronic display and the temperature measurements at the plurality of locations of the electronic display, and adjusting the image data based on the temperature of the pixel.

### CROSS-REFERENCE TO RELATED APPLICATIONS

This application claims priority to U.S. Provisional Application No. 63/699,718, filed Sep. 26, 2024, which is incorporated by reference herein in its entirety.

### BACKGROUND

The present disclosure relates to estimating a thermal profile of an electronic device to enable adjusting image data to compensate for temperature-based variations of an electronic display of the electronic device.

Display pixels of an electronic display may exhibit different behavior at different temperatures. To maintain uniformity, image processing circuitry may adjust image data for the display pixels based on the temperature of the display pixels. For example, image processing circuitry may adjust image data based on temperature data generated by temperature sensors placed throughout the display. When the adjusted image data is programmed into the electronic display, the resulting image may accurately reflect an intended image.

Different areas of a display may experience different amounts of heating due to, for example, different image data being displayed by the different areas and exposure to different heat sources within the electronic devices. As such, numerous temperature sensors may be arranged throughout the display to accurately characterize the temperatures at each area. However, as devices become more compact, it may be less practical to include a temperature sensor for each area of a display.

### SUMMARY

As mentioned, pixels of a display may perform differently based on a temperature of the pixel. For example, temperature may impact a response time, color accuracy, brightness, or burn-in effects of the pixel. Further, different areas of a display may experience different amounts of heating due to, for example, different image data displayed by the different areas and exposure to different heat sources within an electronic device. As such, different adjustments may be made to pixels in each of the different areas to compensate for the temperature-based variations. However, as devices become more compact, it may be less practical to include a temperature sensor at each of numerous different areas of the display to characterize temperatures at each of the areas. Embodiments disclosed herein are directed towards techniques for compensating for temperature-based variations of a display based on a heat model of the display.

For example, embodiments disclosed herein may include determining a temperature of a pixel of a display based on a heat model of the display and temperature measurements at a plurality of locations of the display. The heat model may be generated based on image data to be adjusted for display via the display, and may allow an inference of a temperature of the pixel when displaying the image data. For example, a device may generate more heat at the pixel when displaying image data that is relatively bright at or around the pixel, and the device may generate less heat at the pixel when displaying image data that is relatively dim at or around the pixel. As such, the image data may be adjusted to compensate for temperature-based variation of the pixel based on the determined temperature of the pixel, and the adjusted image data may more accurately reflect an intended image when displayed by the display.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a perspective view of a headset representing an example of the electronic device of FIG. 1, according to embodiments of the present disclosure;

FIG. 8 is a block diagram of the electronic device of FIG. 1, including temperature estimation circuitry and temperature compensation circuitry that may adjust image data to compensate for temperature-based variations of pixels of a display of the electronic device, in accordance with an embodiment;

FIG. 9 is an illustration of the electronic device of FIG. 1, including temperature sensors arranged at locations of the display, in accordance with an embodiment;

FIG. 10 is an illustration of the electronic device of FIG. 1, including regions of a heat model, in accordance with an embodiment;

FIG. 11 is an illustration of the electronic device of FIG. 1, including the temperature sensors and the regions of the heat model, in accordance with an embodiment; and

FIG. 12 is a flow chart of a method for determining a temperature of a pixel and adjusting image data of the pixel based on the determined temperature, in accordance with an embodiment.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

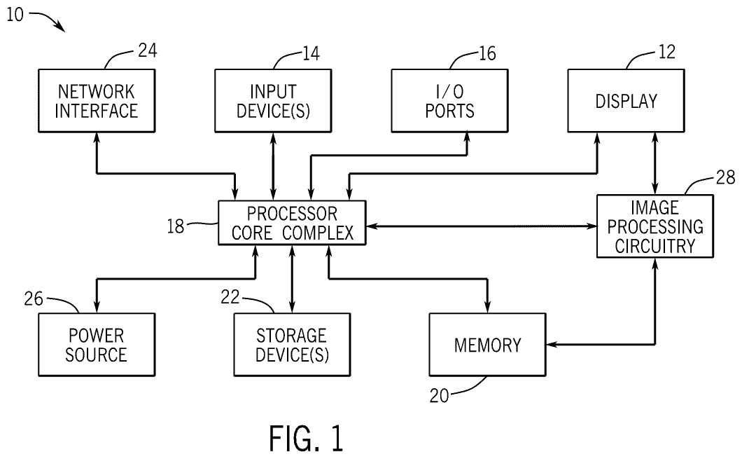

FIG. 1 is a block diagram of an electronic device 10 including an electronic display 12, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, earphones, a headset, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), and image processing circuitry 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component. Further, it should be noted that the electronic device 10 may include dithering circuitry to perform embodiments described herein. Additionally, the image processing circuitry 28 (e.g., a graphics processing unit) may be included in the processor core complex 18.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18 or the electronic display 12. For example, the power source 26 may include a power supply rail and/or a ground terminal coupled to the one or more components in the electronic device 10, such as the processor core complex 18 or the electronic display 12, to provide the electrical power. Thus, the power source 26 may include any suitable source of energy, such as a rechargeable lithium polymer (Li-poly) battery or an alternating current (AC) power converter.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may control light emission from display pixels to present visual representations of information, such as a graphical user interface (GUI) of an operating system, an application interface, a still image, or video content, by displaying frames based at least in part on corresponding image data. The electronic display 12 may display frames of image data based at least in part on image data generated by the processor core complex 18 and/or by the image processing circuitry 28. Additionally or alternatively, the electronic display 12 may display frames based at least in part on image data received via the network interface 24, an input device, and/or one of the I/O ports 16.

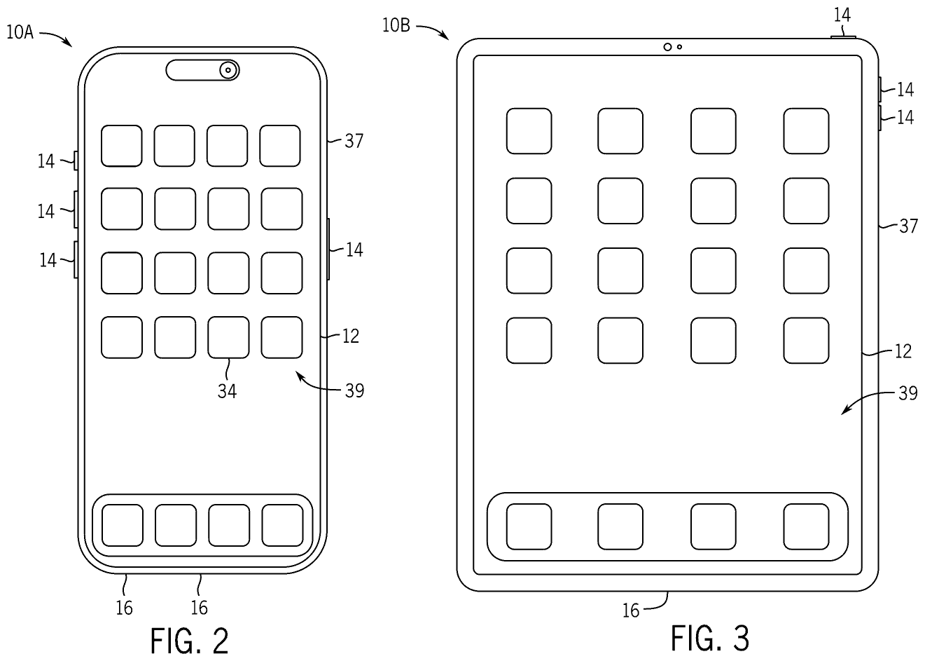

To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc. The handheld device 10A includes an enclosure 37 (e.g., housing). The enclosure 37 may protect interior components from physical damage or shield them from electromagnetic interference, such as by surrounding the electronic display 12. The electronic display 12 may display a graphical user interface (GUI) 39 having an array of icons. As such, when an icon 34 is selected either by an input device 14 or a touch-sensing component of the electronic display 12, an application program may launch.

The input devices 14 may be accessed through openings in the enclosure 37. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

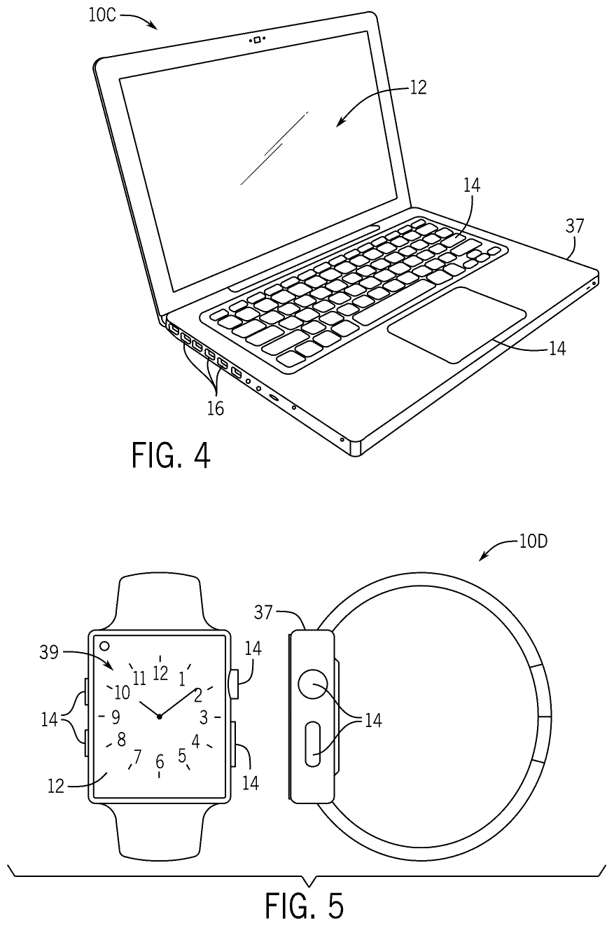

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc.

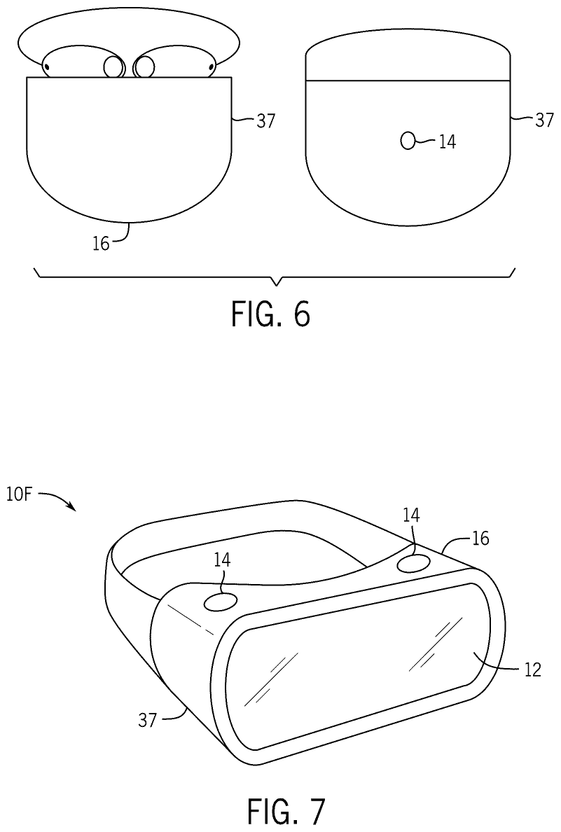

Another example of a suitable electronic device 10, specifically an audio device 10E, is shown in FIG. 6. For illustrative purposes, the audio device 10E may be an AIRPODS® model available from Apple Inc. Another example of a suitable electronic device 10, specifically a headset 10F (e.g., an extended reality (XR), mixed reality (MR), virtual reality (VR), and/or augmented reality (AR) headset), is shown in FIG. 7. For illustrative purposes, the headset 10F may be a VISION PRO® model available from Apple Inc.

As depicted, the tablet device 10B, the computer 10C, the watch 10D, and the headset 10F each also includes an electronic display 12, input devices 14, I/O ports 16, and an enclosure 37. The electronic display 12 may display a graphical user interface (GUI) 39. As shown in FIG. 5, the GUI 39 may show a visualization of a clock. When the visualization is selected either by the input device 14 or a touch-sensing component of the electronic display 12, an application program may launch, such as to transition the GUI 39 to presenting the icons 34 discussed with respect to FIGS. 2 and 3. Further as depicted, the audio device 10E may include the input devices 14, the I/O ports 16, and the enclosure 37.

In any case, as described above, processing image data may improve an image to be displayed by an electronic device. As a result, processing the image data may improve a user interaction or experience with the electronic device 10, such as by enabling the user to view an image more clearly. For example, the image processing circuitry 28 may reference an LUT and perform curvature interpolation based on entries in the LUT in order to determine an interpolation value for use in processed image data. The processed image data may then be used to display a corresponding image on the electronic display 12.

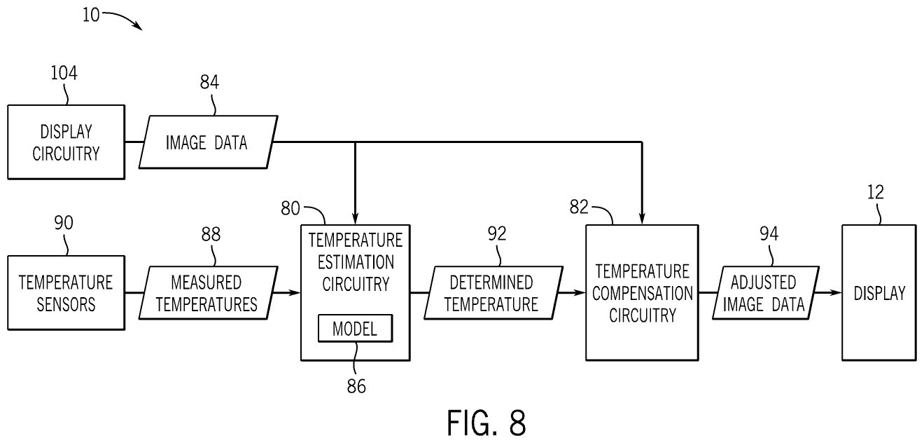

FIG. 8 is a block diagram of the electronic device 10, including temperature estimation circuitry 80 and temperature compensation circuitry 82 that may adjust image data 84 to compensate for temperature-based variations of pixels of the display 12. The temperature estimation circuitry 80 and the temperature compensation circuitry 82 may include or be part of the image processing circuitry 28 of FIG. 1, for instance. In the illustrated example, the temperature estimation circuitry 80 may generate a heat model 86 based on image data 84 received from display circuitry 104, which may be part of the image processing circuitry 28, such as a display pipeline, that may prepare image data for display on the electronic display. In some embodiments, the temperature estimation circuitry 80 may also be part of the image processing circuitry 28, and may be part of the display pipeline. The heat model 86 may include a regression model, such as a linear regression model, and may characterize heat experienced by each of one or more regions of the display 12 when the display 12 displays image data, such as the image data 84. Each of the one or more regions may include one or more pixels and, as such, the temperature estimation circuitry 80 may use the heat model 86 to determine a heat experienced by a pixel within a respective region of the one or more regions.

The temperature estimation circuitry 80 may also receive measured temperatures 88 from temperature sensors 90, which may include, for example, thermocouples or other suitable temperature sensors. The temperature sensors 90 may be arranged at various locations throughout the display 12 to generate the measured temperatures 88 at the various locations. For example, the measured temperatures 88 may include temperatures near components within a device (e.g., beneath the display 12) that generate heat, and/or or at locations not near heat-generating components. As such, the measured temperatures 88 may characterize heat generated by both the display 12 and other components of a device that may generate heat. The temperature estimation circuitry 80 may, based on the heat model 86 and measured temperatures 88 received from temperature sensors 90, determine a temperature 92 of a pixel. For example, the temperature estimation circuitry 80 may reference a temperature of a region of the heat model 86 in which the pixel is located, along with the measured temperatures 88, to determine the temperature 92 of the pixel. The determined temperature 92 may thus be determined based on heat generated by the display (e.g., as indicated by the heat model 86 and the measured temperatures 88) and heat generated by other components (e.g., as indicated by the measured temperatures 88).

The temperature estimation circuitry 80 may provide the determined temperature 92 of the pixel to temperature compensation circuitry 82, and the temperature compensation circuitry 82 may adjust the image data 84 based on the determined temperature 92 to generate adjusted image data 94. For example, to compensate for color variation based on the determined temperature 92 for a pixel, the temperature compensation circuitry 82 may compute a temperature gain value for the pixel. To compute temperature gain value, the temperature compensation circuitry 82 may multiply a temperature sensitivity of the display 12 (e.g., red, green, and blue values) by the difference between the determined temperature 92 of the pixel and a reference temperature. The temperature compensation circuitry 82 may adjust the image data 84 to generate the adjusted image data 94 based on the temperature gain value. Additionally or alternatively, the temperature compensation circuitry 82 may use the determined temperature 92 to compensate for brightness variations of a pixel, such as when one or more sub-pixels of a pixel (e.g., red, green, or blue sub-pixels) emit more light than other sub-pixels of the pixel.

The temperature compensation circuitry 82 may provide the adjusted image data 94 to the display 12 for display. By compensating for color variations based on the determined temperature 92, the adjusted image data 94 may more closely reflect an intended image of the image data 84. As may be appreciated, in some cases, the device 10 may determine a temperature 92 and adjust the image data 84 for each of a plurality of pixels and/or regions of the display 12 to generate a complete, accurate image for display via the display 12.

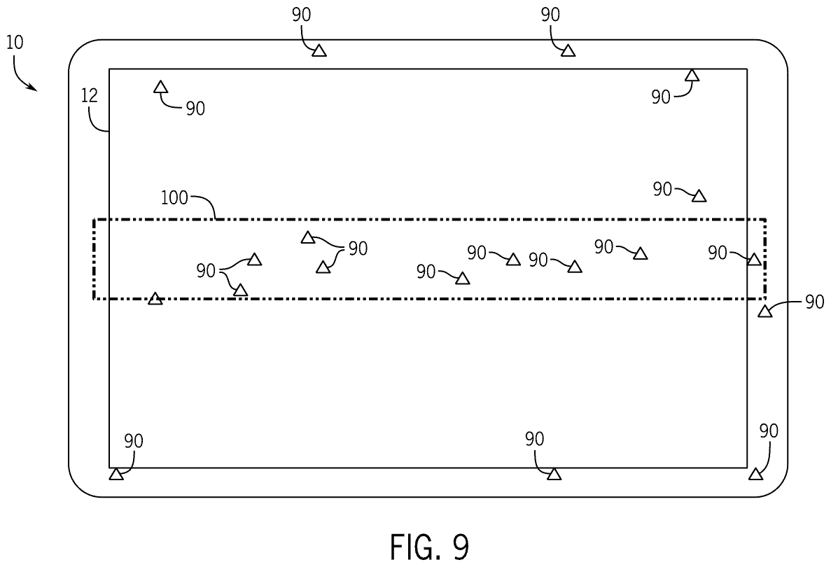

FIG. 9 is an illustration of the electronic device 10, including the temperature sensors 90 arranged at locations of the display 12. In the illustrated example, the electronic device 10 includes an area 100 in which heat-generating components are included beneath the display 12. For example, the area 100 may include more heat-generating components, such as processing circuitry, power circuitry, and the like, than other areas of the electronic device 10. Because the area 100 includes heat-generating components, the electronic device 10 may have a higher density of the temperature sensors 90 at or near (e.g., adjacent to) the area 100, as illustrated. For example, the electronic device 10 may use temperature measurements generated by the temperature sensors 90 for purposes such as thermal or power management of one or more components within the area 100, performance optimization of one or more components within the area 100, and so on. Further, the area 100 may include more heat-dissipating components (e.g., heatsinks) that cause further variations in temperatures of the display 12, such as by distributing heat throughout the display 12, which may be measured by the temperature sensors 90.

However, the electronic device 10 may include fewer temperature sensors 90 at locations of the display 12 not near the area 100, as illustrated. As may be appreciated, this may be due to a lack of heat-generating components relative to the area 100, power and space restraints that preclude additional temperature sensors, and so on. Because there may be fewer temperature sensors 90 in some locations of the display 12, it may be difficult to determine temperatures of pixels of the display 12 at those locations based only on temperature measurements from the temperature sensors 90. However, any location of the display 12, including locations where few temperature sensors 90 are present, may still experience varying temperatures. For example, image data may include bright content that causes the display 12 to generate substantial heat in areas where there are few temperature sensors. It may thus be desirable to determine a temperature of a pixel of the display 12 based on a heat model of the display and/or by supplementing temperature measurements generated by the temperature sensors 90 with the heat model.

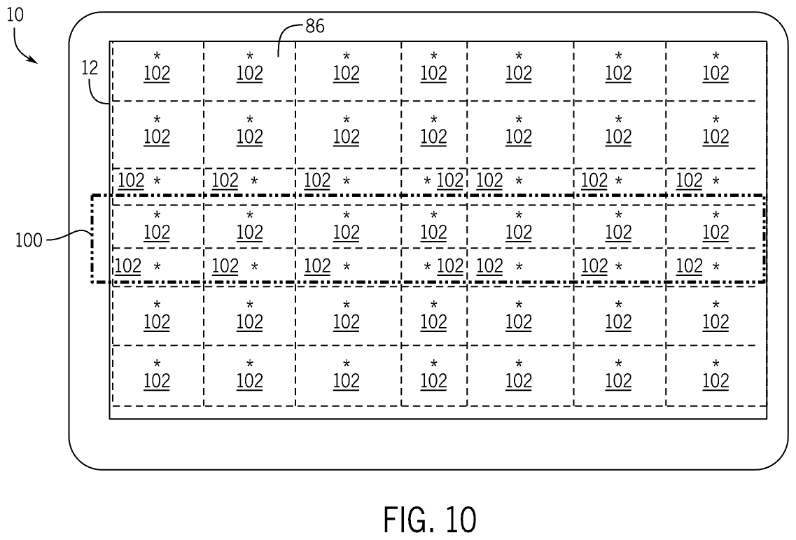

FIG. 10 is an illustration of the electronic device 10, including regions 102 of the heat model 86. Each of the regions 102 may correspond to a group of pixels within the respective region, and a temperature of the respective region, according to the heat model 86, may represent a temperature of the one or more pixels. For example, a temperature of a region of regions 102 may correspond to an average temperature of pixels within the region. The temperature of each region of the region 102 may indicate an amount of heat that the pixels within the region may experience when the display 12 displays image data, for instance. As mentioned, the heat model 86 may include a linear regression representation of temperatures at each of the regions 102.

As illustrated, the regions 102 may be of various sizes. For example, regions 102 near the area 100 in which heat-generating components are present beneath the display may be smaller than regions not near the area 100. As may be appreciated, the additional granularity offered by the smaller regions may better account for increased variations in temperatures caused by heat-generating and heat-dissipating components in the area 100. On the other hand, including larger regions 102 where less heat-generating components are present may reduce the consumption of resources associated with processing or storing the heat model 86.

While the regions 102 are shown as examples of regions that may be included with a heat model 86, regions of other examples may be of various other numbers, dimensions, sizes, shapes, and the like. For example, regions of a heat model 86 may be more compact (e.g., a region of one pixel) or broader (e.g., a region covering half of the display) based on, for example, granularity desires or available computational resources. In another example, regions may be arranged in a radial grid, such as to characterize heat radiating outward from centrally-located processing components. Further, while each region of the regions 102 is described as representing an average of the pixels within the region, the region may, additionally or alternatively, represent different temperatures for pixels of the region, such as a gradient of temperatures among pixels within the region. For example, the region may represent relatively higher temperatures for pixels of the region that are near heat-generating components and/or bright pixels, and may represent relatively lower temperatures for other pixels of the region.

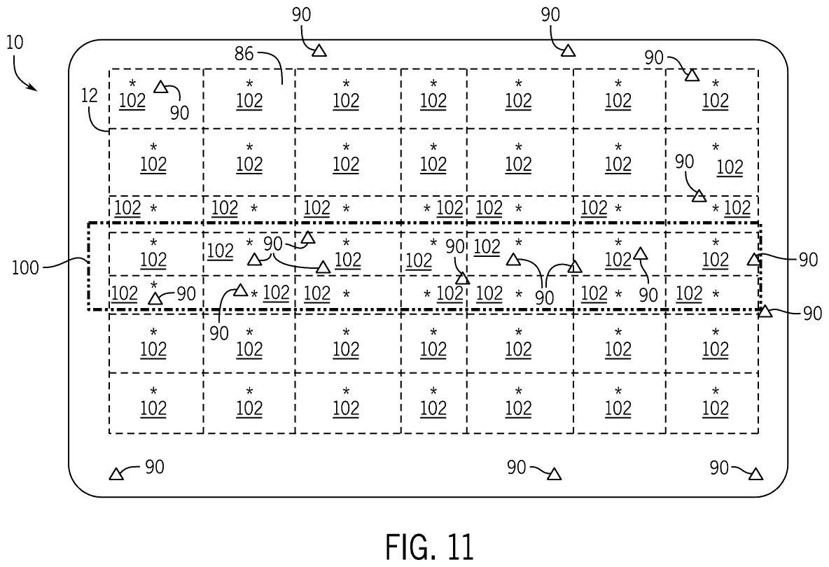

FIG. 11 is an illustration of the electronic device 10, including the temperature sensors 90 and the regions 102 of the heat model 86. As illustrated, the temperature sensors 90 may be more numerous near the area 100 with heat-generating components than in other areas of the electronic device 10. This increased granularity may be provided to account for greater variations in heat due to heat-generating components and heat-dissipating components, for instance. Likewise, the heat model 86 may include more numerous and compact regions 102 near the area 100 than in other areas of the display 12.

A temperature of a pixel within any region of the regions 102 may be determined based on both measured temperatures generated by the temperature sensors 90 and temperatures represented by the heat model 86. In some cases, the measured temperatures generated by the temperature sensors 90 may be given greater or lesser weight than the heat model 86 when determining a temperature of a pixel. For example, for a pixel within a region 102 that includes a temperature sensor 90, the measured temperature generated by the temperature sensor 90 within the region may be given a greater weight than the temperature of the region 102 as represented by the heat model. For a pixel within a region 102 that does not include a temperature sensor 90, the temperature of the region 102 as represented by the heat model may be given greater weight.

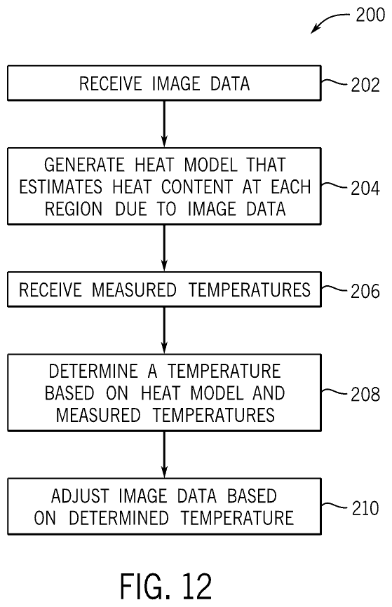

FIG. 12 is a flow chart of a method 200 for determining a temperature of a pixel and adjusting image data of the pixel based on the determined temperature. The method 200 may be performed by the electronic device 10, such as by the temperature estimation circuitry 80 and/or the temperature compensation circuitry 82, for example. Further, while the method 200 is described as being performed for a pixel of a display, a temperature may be determined, and image data may be adjusted, for multiple pixels, such as for each pixel of a region of a display or each pixel in a display.

In block 202, the temperature estimation circuitry 80 may receive the image data 84. The image data 84 may include display content for a pixel of the display 12, and may be sent from the display circuitry 104. The image data 84 may, for example, include one or more color values (e.g., red, green, and blue values) for each pixel, and the one or more color values may be adjusted to compensate for temperature-based variations.

In block 204, the temperature estimation circuitry 80 may generate the heat model 86 of the display 12. The heat model 86 may, for example, include a linear regression representation of an estimated heat content due to the image data 84 at one or more regions 102 of the display. Each of the regions 102 of the heat model 86 may correspond to one or more pixels within the respective region, and a temperature of the respective region, according to the heat model 86, may represent a temperature of the one or more pixels. For example, a temperature of a region of regions 102 may correspond to an average temperature of pixels of the region and/or a gradient of temperatures of pixels of the region. The temperature of each region 102 may indicate an amount of heat that the pixels within the region may experience when the display 12 displays the image data 84.

In block 206, the temperature estimation circuitry 80 may receive the measured temperatures 88 from the one or more temperature sensors 90. As mentioned, the temperature sensors 90 may be arranged at various locations throughout the display 12 to generate the measured temperatures 88 at the various locations. For example, the measured temperatures 88 may include temperatures near components within a device that generate substantial amounts of heat, and/or or at locations not near heat-generating components. As such, the measured temperatures 88 may characterize heat generated by both the display 12 and other components of a device that may generate heat.

In block 208, the temperature estimation circuitry 80 may determine (e.g., calculate) a temperature 88 of the pixel based on the measured temperatures 88 received in block 206 and the heat model 86 generated in block 204. For example, the temperature estimation circuitry 80 may reference a temperature of a region of the heat model 86 in which the pixel is located along with the measured temperatures 88 to determine the temperature 92 of the pixel. The determined temperature 92 may thus be determined based on heat generated by the display (e.g., as indicated by the heat model 86 and the measured temperatures 88) and heat generated by other components (e.g., as indicated by the measured temperatures 88).

In block 210, the temperature compensation circuitry 82 may adjust the image data 84 to generate adjusted image data 94 based on the temperature 92 determined by the temperature estimation circuitry 80. For example, to compensate for color variation based on the determined temperature 92 for a pixel, the temperature compensation circuitry 82 may compute a temperature gain value for the pixel. To compute temperature gain value, the temperature compensation circuitry 82 may multiply a temperature sensitivity of the display 12 (e.g., red, green, and blue values) by the difference between the determined temperature 92 of the pixel and a reference temperature. The temperature compensation circuitry 82 may adjust the image data 84 to generate the adjusted image data 94 based on the temperature gain value. The temperature compensation circuitry 82 may also provide the adjusted image data 94 to the display 12. By compensating for color variations based on the determined temperature 92, the adjusted image data 94 may more closely reflect an intended image of the image data 84.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving image data to be adjusted for display on an electronic display;
receiving temperature measurements at a plurality of locations of the electronic display;
generating a heat model of the electronic display based on the image data;
determining a temperature of a pixel based on the heat model of the electronic display and the temperature measurements at the plurality of locations of the electronic display; and
adjusting the image data based on the temperature of the pixel.

2. The method of claim 1, wherein the heat model of the electronic display comprises one or more regions of the electronic display.

3. The method of claim 2, wherein the heat model comprises a linear regression representation of temperatures at the one or more regions of the electronic display.

4. The method of claim 2, wherein the one or more of regions comprise regions of varying dimensions.

5. The method of claim 4, wherein regions of the one or more of regions that are adjacent to processing components are larger than regions that are not adjacent to the processing components.

6. The method of claim 2, wherein a region of the one or more regions does not include a location of the plurality of locations of the electronic display.

7. The method of claim 2, comprising calculating a temperature of a region of the one or more regions based on a local temperature measurement of the temperature measurements, the local temperature measurement indicating heat generated by the electronic display at the region when displaying the image data.

8. The method of claim 1, wherein the plurality of locations corresponds to a plurality of temperature sensors.

9. The method of claim 8, wherein the plurality of temperature sensors comprises one or more thermocouples.

10. An electronic device comprising:
display circuitry configured to provide image data of a pixel to a display via temperature compensation circuitry; and
the temperature compensation circuitry configured to:
generate a heat model of the display based on the image data;
determine a temperature of the pixel based on the heat model; and
adjust the image data based on the temperature of the pixel.

11. The electronic device of claim 10, comprising one or more temperature sensors configured to generate temperature measurements at a plurality of locations of the display, and wherein the temperature compensation circuitry is configured to determine the temperature of the pixel based on the heat model and the temperature measurements at the plurality of locations of the display.

12. The electronic device of claim 11, wherein locations of the plurality of locations that are not adjacent to processing components are farther apart than locations that are adjacent to the processing components.

13. The electronic device of claim 10, wherein the heat model of the display comprises one or more regions of the display.

14. The electronic device of claim 13, wherein each of the one or more regions comprise one or more respective pixels.

15. The electronic device of claim 13, wherein the regions comprise rectangular sections of the display.

16. The electronic device of claim 13, wherein the heat model comprises a linear regression representation of temperatures at the one or more regions of the display.

17. A non-transitory, computer-readable medium comprising instructions that, when executed by processing circuitry, are configured to cause the processing circuitry to process image data to be adjusted for display via a display at least in part by:
receiving temperature measurements at a plurality of locations of the display;
generating a heat model of the display based on the image data;
determining a temperature of a pixel of the display based on the heat model of the display and the temperature measurements at the plurality of locations of the display; and
adjusting the image data to compensate for temperature-based color variation of the pixel based on the temperature.

18. The non-transitory, computer-readable medium of claim 17, wherein adjusting the image data to compensate for temperature-based color variation of the pixel based on the temperature comprises computing a temperature gain value for the pixel based on the temperature.

19. The non-transitory, computer-readable medium of claim 18, wherein computing the temperature gain value for the pixel based on the temperature comprises multiplying a temperature sensitivity of the display by a difference between the temperature and a reference temperature.

20. The non-transitory, computer-readable medium of claim 17, wherein the heat model indicates a heat experienced by the pixel due to the display displaying the image data.
